(19) United States
(12) Patent Application Publication
(10) Pub. No.: US 2026/0229909 A1
(43) Pub. Date: Aug. 6, 2026

(54) SYSTEM TO DELIVER POWER GREATER THAN AN AC POWER SOURCE'S CAPACITY FOR INTERMITTENT LOADS

(71) Applicant: DSP Solutions Inc., Oxnard, CA (US)

(72) Inventors: Anthony T. D’Amore, Newbury Park, CA (US); Juan Rodriguez, Moorpark, CA (US)

(73) Assignee: DSP Solutions Inc., Oxnard, CA (US)

(21) Appl. No.: 19/324,785

(22) Filed: Sep. 10, 2025

Related U.S. Application Data
(60) Provisional application No. 63/693,530, filed on Sep. 11, 2024.

(51) Int. Cl. H02J 7/00; H02J 7/02

(52) U.S. Cl. CPC H02J 7/865; H02J 7/02; H02J 7/855; H02J 2207/20

(57) ABSTRACT

This application generally relates to a power buffer device configured to provide more power to a load than is currently available from an alternating current (AC) power source connected to the power buffer device.

### BACKGROUND

### 1. Technical Field

This application relates to power delivery systems and, in particular, to power delivery systems for delivering power greater than an alternating current (AC) power source capacity for intermittent loads.

### 2. Related Art

Under some circumstances, a powered device may need greater power than is available from a standard AC power source. Standard power supply systems are not configured to handle certain loads and electrical safety devices, such as breakers which detect an overload condition, will open the electrical connection to such a load to deactivate power delivery to that load. Accordingly, there is a need for systems, methods, components, and apparatuses described herein that can provide power to loads connected to a standard AC power source that require more power than the standard AC power source can supply on its own.

### SUMMARY

This application generally relates to power delivery systems for delivering power greater than an alternating current (AC) power source capacity for intermittent loads.

According to one implementation a system for driving a load is disclosed having power input adapted to receive AC electrical power from an AC power source, the AC electrical power comprising an AC input voltage. The system also includes a voltage converter comprising an output, the voltage converter is connected to the power input, such that the voltage converter can receive electrical power from the AC power source, where the voltage converter is adapted to draw a limited current from the AC power source, where the limited current does not exceed a current limit set point, and where the voltage converter produces an AC output voltage at the output. The system further includes a rechargeable battery coupled to the output of the voltage converter, such that the voltage converter is adapted to charge the rechargeable battery, as well as a second voltage converter further adapted to be coupled to an output of the rechargeable battery and to the load. The load connected to the second voltage converter is simultaneously powered by the rechargeable battery and by the voltage converter, where the average power supplied by the rechargeable battery and by the voltage converter to the load in a finite time interval differs from an average power supplied by the AC power source to the power input of the voltage converter.

According to another implementation, a system for driving a load includes a power input adapted to receive AC electrical power from an AC power source, the AC electrical power comprising an AC input voltage, and a voltage converter comprising an output, where the voltage converter is connected to the power input, such that the voltage converter can receive electrical power from the AC power source, where the voltage converter is adapted to draw a limited current from the AC power source, where the limited current does not exceed a current limit set point, and where the voltage converter produces an AC output voltage at the output. The system also includes a rechargeable battery coupled to the output of the voltage converter, such that the voltage converter is adapted to charge the rechargeable battery. The load connected to the second voltage converter is configured to be simultaneously powered by the rechargeable battery and by the voltage converter, wherein the average power supplied by the rechargeable battery and by the voltage converter to the load in a finite time interval differs from an average power supplied by the AC power source to the power input of the voltage converter.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 is a block diagram of a power delivery system in accordance with a first embodiment.

FIG. 2 is a block diagram of a power delivery system in accordance with a second embodiment.

FIG. 3 is a block diagram of a power delivery system in accordance with a third embodiment.

### DETAILED DESCRIPTION

The power buffer device disclosed herein allows for appliances (loads) to exist which require power greater than the available power from an alternating current (AC) source. Normally, in the United States for example, standard AC power wall outlets are limited to 15 amps (A) at 120 Volts (V), moreover they are often shared with other power consumers. In this case, any loads over approximately 1500 Watts are not permitted or usable without activating an electrical safety device such as a breaker which senses an overload condition and opens the electrical connection thus deactivating the power consumers. One example power consumer might be a home audio subwoofer which can consume 3000 Watts during use. Currently a subwoofer of this power level could not be plugged into a standard US wall outlet.

In example embodiments below, the disclosed power buffer device includes a voltage converter that draws current-limited power from the AC power source, and further, the DC output voltage of the voltage converter may comprise a regulated voltage. The voltage converter may have current limiting circuitry, and may further be adapted to receive a user input (i.e., an input that is manually adjustable by a user, as opposed to a designed-in and fixed current limit) current limit set point. In high-load conditions, the voltage converter can supply current and power to a load up to the manually adjustable current limit set point, and a rechargeable battery can supply current drawn by the audio amplifier to the extent that the current exceeds the current limit set point.

In some embodiments, the voltage output of the rechargeable battery will typically be greater than the AC input voltage from the AC power source. Further, the average power supplied to the audio amplifier by the rechargeable battery in the finite time interval is greater than the average power supplied by the AC power source to the power input of the voltage converter, typically when the finite time interval is short. Moreover, the average power supplied to the load in the finite time interval can also be less than the average power supplied by the AC power source to the power input of the voltage converter, typically when the finite time interval is long (relative to the above-referenced “short” interval).

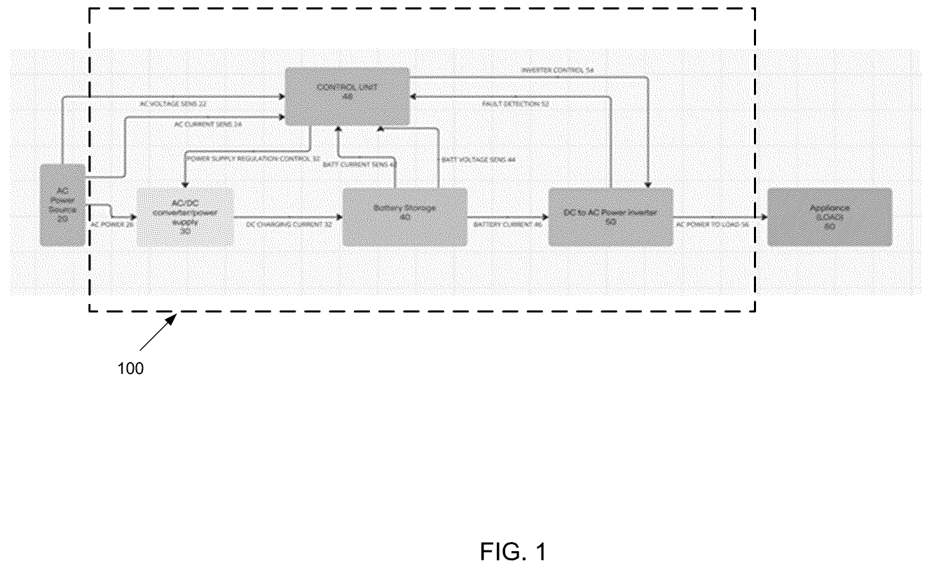

Referring to FIG. 1, in one embodiment the power buffer device 100 is connected to an AC Power Source 20, which may be as a standard 120 V wall outlet. A control unit 48 of the power buffer device 100 is programmable by the user for maximum allowable current from AC Power Source 20. This sets a limit on the input current to an AC/DC converter and power supply 30 that is acting as a charger for Battery Storage 40 charger. The batteries in Battery Storage 40 are chosen so that the output power is significantly greater than the maximum allowable input power from the AC Power Source. In this implementation, the Battery Storage 40 powers a DC to AC Inverter 50 which then powers the Appliance/Load (60). This arrangement allows for AC power output to be greater than AC power input for intermittent loads, such as but not limited to audio amplification. In one implementation, the appliance/load may be an audio component such as a subwoofer.

The AC/DC converter and power supply 30 may receive the AC input from the AC Power Source 20. The output of the AC/DC converter 30 may be a DC charging current 32 that is fed to the Battery Storage 40. The AC/DC converter 30 may be current limited, and may have a regulated output 32, so that regardless of the demands of the appliance 60, the AC/DC converter 30 will draw a continuous current or a limited current (depending on the charge level of Battery Storage 40) from the AC power source 20. The voltage converter provides its output current to the audio amplifier such that the voltage converter does not draw current from the AC power source in excess of the current limit set point. The AC/DC converter 30 also provides some of its output current to the rechargeable battery 50. The current draw of AC/DC converter 30 can be selected by design or can be manually input by a user, with the only requirement being that the long-term average power delivered from AC power source 20 to Battery Storage 40 meets the average power needs of appliance 60, as discussed in detail below. Thus, the AC/DC converter 30 functions essentially as a battery charger, and may in example embodiments be a battery charger, and it may also provide for electrical isolation between the AC power source 20 and the appliance 60.

The control unit 48 of the power buffer device 100 may include a microprocessor and appropriate interface circuitry to receive inputs from various sensors at a control unit input/output interface to monitor the state of charge or temperature of rechargeable Battery Storage 40, incoming voltage from the AC power source 20, inputs from other stages or circuits of the device 100, or environmental factors such as temperature. Sensors usable with control unit 48 can include, for example, temperature sensors, current sensors, voltage sensors or lead wires to conduct battery voltage to interface circuitry of the control unit 48 or AC/DC converter 30. The control unit 48 may also include or be connected to a user interface, via a wireless antenna and wireless interface, or a wired interface connected to input/output interface of the control unit. The wired or wireless user interface allows a user to control the power buffer device 100, or part of it, for example, by manually entering, changing, or adjusting a current limit set point. Thus, the control unit 48 may give a user the option to manually select the maximum allowable current input from the AC power source 20, or the current limit set point can be set “intelligently” by programming of the microprocessor using any or all of the above inputs to determine an optimal or efficient current limit level. The current level may optimize charge conditions and protect the power source 20 and the rechargeable Battery Storage 40. One example of a suitable wired or wireless user interface to the control unit 48 is shown in U.S. Pat. No. 11,594,955, the entirety of which is hereby incorporated herein by reference.

As noted above, the device 100 may include a Battery Storage 40. The battery storage 40 may include one or more batteries of the same or different types, and the battery storage 40 may be rechargeable. One example of a suitable rechargeable battery type is a lithium-ion battery. Any of a number of battery types may be implemented and are selected to have the necessary output power to supply the extra power that may be demanded by the appliance/load 60 over that available from the AC power input from the AC power source 20.

A direct current to alternating current (DC to AC) power inverter 50 may be connected to the battery current 46 output by battery storage 40. Additionally, the control unit 48 monitors a fault detection line 52 from the inverter 50 and the inverter 50 may be adjusted by the control unit 48 over an inverter control line 54. The inverter outputs AC power to the appliance (load) 60 over an AC power to load 56 connection.

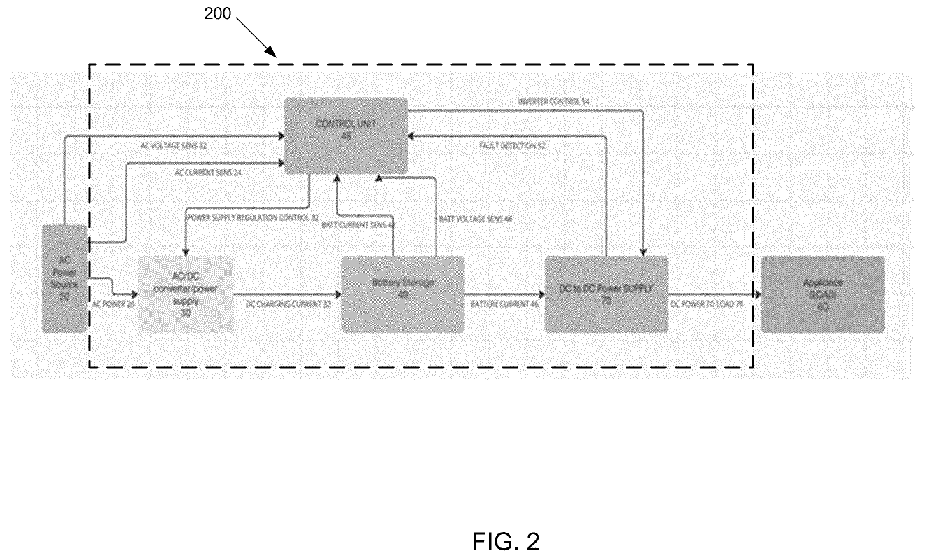

FIG. 2 illustrates an alternative embodiment of the power buffer device of FIG. 1. The power buffer device 200 of FIG. 2 includes all of the same basic components of the power device of FIG. 1, with the difference being that a DC to DC power supply 70 is used to output DC power along a DC power to load line 78 rather than a DC to AC power inverter 50 as in FIG. 1. The DC to DC converter 70 may be used to match the voltage of the power buffer 200 to the appliance/load 60, when the appliance/load 60 is expecting a DC input.

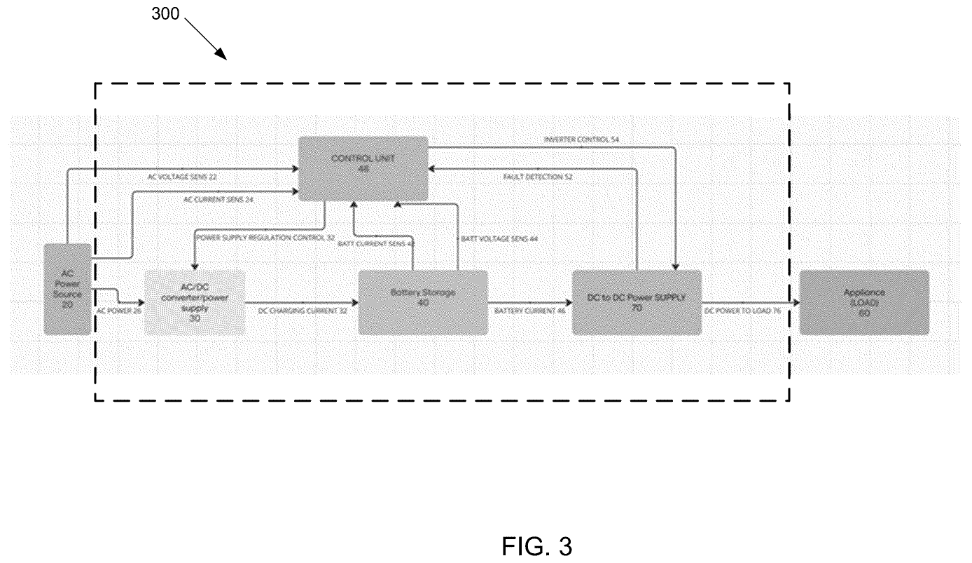

In yet another variation, as shown in FIG. 3, the power buffer device 300 is again is connected to the AC Power Source 20. The control unit 48 is programmed by the user for maximum allowable current from AC Power Source 20. This sets a limit on the input current to the AC/DC power supply 30 acting as the Battery Storage 40 charger. As with the embodiments of FIGS. 1 and 2, the batteries in the battery storage 40 are chosen so that the output power is significantly greater than the maximum allowable input power. However, unlike the power buffer device versions 100, 200 of FIGS. 1 and 2, the working voltage of Battery Storage 40 output on DC power to load line 76 is such that the appliance load 60 is connected directly to the battery storage 40 rather than using a DC-to-DC power supply 70 (FIG. 2) or DC to AC power inverter 50 (FIG. 1). Again, this arrangement allows for DC power output to be greater than AC power input for intermittent loads.

As described above, the power buffer device 100, 200, 300 has no direct connection to the AC power source 20. Instead, the sources of power (AC power source 20) and DC/AC supply 50 or DC/DC supply 70 or Battery 40 are connected in series, not parallel. This isolates the transient loads from the AC power source 20.

In different embodiments, the power buffer device 100, 200, 300 can be built into the electrical power consumers, or it can be a standalone unit connectable to various power consumers.

While various embodiments have been described, it will be apparent to those of ordinary skill in the art that many more embodiments and implementations are possible. Accordingly, the embodiments described herein are examples, not the only possible embodiments and implementations.

What is claimed is:

1. A system for driving a load comprising:
a power input adapted to receive AC electrical power from an AC power source, the AC electrical power comprising an AC input voltage;
a voltage converter comprising an output, the voltage converter connected to the power input, such that the voltage converter can receive electrical power from the AC power source, wherein the voltage converter is adapted to draw a limited current from the AC power source, wherein the limited current does not exceed a current limit set point, and wherein the voltage converter produces an AC output voltage at the output;
a rechargeable battery coupled to the output of the voltage converter, such that the voltage converter is adapted to charge the rechargeable battery;
a second voltage converter further adapted to be coupled to an output of the rechargeable battery and to the load; and
wherein the load connected to the second voltage converter is configured to be simultaneously powered by the rechargeable battery and by the voltage converter, wherein an average power supplied by the rechargeable battery and by the voltage converter to the load in a finite time interval differs from an average power supplied by the AC power source to the power input of the voltage converter.

2. The system of claim 1, wherein the second voltage converter comprises a DC-to-AC power converter.

3. The system of claim 1, wherein the second voltage converter comprises a DC-to-DC power converter.

4. A system for driving a load comprising:
a power input adapted to receive AC electrical power from an AC power source, the AC electrical power comprising an AC input voltage;
a voltage converter comprising an output, the voltage converter connected to the power input, such that the voltage converter can receive electrical power from the AC power source, wherein the voltage converter is adapted to draw a limited current from the AC power source, wherein the limited current does not exceed a current limit set point, and wherein the voltage converter produces an AC output voltage at the output;
a rechargeable battery coupled to the output of the voltage converter, such that the voltage converter is adapted to charge the rechargeable battery; and
wherein the load connected to the second voltage converter is configured to be simultaneously powered by the rechargeable battery and by the voltage converter, wherein an average power supplied by the rechargeable battery and by the voltage converter to the load in a finite time interval differs from an average power supplied by the AC power source to the power input of the voltage converter.
